(19) United States
(12) Patent Application Publication
(10) Pub. No.: US 2011/0094028 A1
(43) Pub. Date: Apr. 28, 2011

(54) Method and Apparatus for Handling a Person

(76) Inventor: Ivo Traykov, Port Orange, FL (US)

(21) Appl. No.: 12/828,220

(22) Filed: Jun. 30, 2010

Related U.S. Application Data
(63) Continuation-in-part of application No. 12/603,745, filed on Oct. 22, 2009.

(51) Int. Cl. A61G 7/10

(52) U.S. Cl. 5/83.1

(57) ABSTRACT

A lightweight, portable device allows a caregiver to fix one or two of the caregiver's lower legs and knees in position with respect to one or two of a patient's lower legs and knees so that the fixed lower legs together support and balance the combined body weight of the caregiver and patient, allowing the caregiver to pivot the patient up or down from a seated position by using the fixed knees as a fulcrum. The device has a central concavity that engages one person's leg below the knee from one direction, and peripheral concavities on either side of the central concavity that engage another person's legs below the knee from the opposite direction. Legs in the peripheral concavities partially straddle the leg in the central concavity. The device may be strapped onto the patient.

This application is a continuation-in-part of U.S. patent application Ser. No. 12/603,745 filed on Oct. 22, 2009, still pending, which is a continuation-in-part of U.S. Pat. No. 7,627,911.

### BACKGROUND

1. Field of the Invention

The present invention relates to an apparatus used to assist in allowing a helper to lift a patient to a standing position and/or move a patient from one surface to another.

2. Technical Background

People who are injured, ill, aged, or in some way disabled often have difficulty changing position, particularly in moving between sitting and standing positions or from one surface to another. An individual's capabilities may change from hour to hour in response to pain, medication, medical precautions and contraindications, the acuteness of the person's condition, the person's emotional state and many other factors. A caregiver must therefore act cautiously each time a patient is moved, protecting both the patient and the caregiver. The caregiver should be able to closely monitor the patient's movement, provide verbal guidance, assist when needed, and intervene to prevent injury.

One way to provide this level of support is to strap the patient into an apparatus capable of independently lifting and supporting the patient's entire weight. The patient may then be raised to or lowered from a standing position, or swung or rolled into a new sitting position. Such devices often incorporate a large metal frame with hydraulic actuators. These may provide excellent control over the patient's position while minimizing exertion by the caregiver, but they are expensive, require considerable operating space, are difficult to move and time-consuming to set up. Busy caregivers who assist many patients seldom have time to struggle with large, complex lifting devices, especially when care requires travel between patients.

Many lighter and simpler lifting devices have been developed, ranging from pivoting posts mounted on platforms to straps that may be attached to a patient to give a caregiver a better grip on the patient. Though more portable than a hydraulic lift, a post mounted on a platform is still awkward to move about and may require more upper body strength than a patient can reliably muster. A simple strap or a strap with an attached grip is easy to transport and attach but forces the caregiver to provide most or all lifting and stabilization force.

Without the help of a device that provides stability and a mechanical advantage, a caregiver who lifts and assists patients must engage in strenuous motions in awkward, unbalanced positions and may suffer consequent work-related injuries, especially when these activities are repeated many times within a short period. According to the Occupational Safety and Health Administration (OSHA), a caregiver who assists a patient who is standing up, sitting down, or transferring laterally to another place is at risk for work-related musculoskeletal disorders (MSDs) such as back injuries, which account for one-third of all occupational injuries and illnesses reported to the Bureau of Labor Statistics (BLS) by employers every year. These are common, expensive and preventable injuries.

What is needed is a light, portable, inexpensive device that addresses OSHA's concerns by decreasing the force a caregiver must use to move a patient and by eliminating the awkward postures required by other methods; that provides constant, direct contact between caregiver and patient, allowing the caregiver to control the patient and his/her movement and ensure a constant level of safety at any given time; and that is sufficiently easy to use, light, portable, and inexpensive that it can be routinely employed.

### SUMMARY OF THE INVENTION

The inventive apparatus is generally a structure that, when placed against at least one of an assisted person's legs and braced with opposing force from at least one of an assisting person's legs, holds the assisted person's knee or knees steady while allowing the assisting person to use the assisting person's body weight to balance the assisted person's body weight over a fulcrum formed by the knees of both people. The assisted person may then be more easily lifted from or lowered to a seated position, shifted laterally to a different position, stabilized, or otherwise handled.

One embodiment of the apparatus is a frame with a lower member having a central concavity opening in one direction and two peripheral concavities opening in the opposite direction. Each concavity is sized to accept a person's leg below the knee. A leg inserted in the central concavity is at least partially straddled by legs inserted in the peripheral concavities. An upper member attached by side members braces against the leg above the knee. Another embodiment may be a single member with opposing central and peripheral concavities that accept knees.

The peripheral concavities engage the legs of a two-legged patient, or the central concavity engages the leg of a one-legged patient. The apparatus may be strapped in place on the patient before a caregiver engages the apparatus. When assisting a two-legged person, a caregiver engages the central concavity. When assisting a one-legged person the caregiver engages the peripheral concavities. In any case, the caregiver faces the patient and engages the apparatus from a direction opposite the patient's. Opposing force against central and peripheral concavities fixes the engaged legs of the caregiver and patient in position.

The caregiver may then directly or indirectly grasp the patient's upper body and use the caregiver's body weight to balance the patient's weight over the engaged knees. The caregiver may then rock backward to move the patient to a standing position or forward to move the patient to a seated position.

Since the apparatus is light, inexpensive, and easy to manufacture, use, clean, and transport, the apparatus may be used effectively in a far wider variety of circumstances than existing devices and methods. All of these features and advantages are illustrated below in the drawings and detailed description that follow.

### BRIEF DESCRIPTION OF THE DRAWINGS

FIG. 1 shows a perspective view of an embodiment fabricated from cylindrical stock to form a frame.

FIG. 2 shows a side elevation view of the embodiment of FIG. 1.

FIG. 3 shows a front elevation view of the embodiment of FIG. 1.

FIG. 4 shows a top plan view of the embodiment of FIG. 1.

FIG. 5 shows a cross-sectional view of the embodiment of FIG. 1.

FIG. 6 shows an embodiment with an adjustable strap.

FIG. 7 shows a perspective view of a seated, two-legged patient with a frame positioned over the patient's knees.

FIG. 8 shows a top cross-sectional view of the embodiment of FIG. 1 attached to a two-legged patient's legs.

FIG. 9 shows a rear elevation view of the embodiment of FIG. 1 with the strap configuration of FIG. 8.

FIG. 10 shows a perspective view of a caregiver engaging the embodiment of FIG. 7.

FIG. 11 shows a perspective view of a caregiver grasping a patient.

FIG. 12 shows a perspective view of a caregiver rocking a seated patient to a standing position.

FIG. 13 shows a perspective view of a caregiver and patient in standing positions.

FIG. 14 shows a perspective view of an embodiment attached to a one-legged patient's leg.

FIG. 15 shows a top cross-sectional view of the embodiment of FIG. 14 attached to a one-legged patient's leg.

FIG. 16 shows a front elevation view of the embodiment of FIG. 15.

FIG. 17 shows a perspective view of a caregiver engaging the embodiment of FIG. 14.

FIG. 18 shows a perspective view of a caregiver grasping a patient.

FIG. 19 shows a perspective view of a caregiver rocking a seated one-legged patient to a standing position.

FIG. 20 shows a perspective view of a caregiver and patient in standing positions.

FIGS. 21 and 22 show perspective views of a caregiver rotating a standing one-legged patient to a new seat.

FIG. 23 shows a perspective view of a caregiver lowering a one-legged patient to a new seat.

FIGS. 24 and 25 show perspective views of a caregiver sliding a two-legged patient from a chair to a bed.

FIG. 26 shows a top plan view of the motion of a two-legged patient being slid from a chair to a bed.

FIGS. 27 and 28 show perspective views of a standing two-legged patient being rotated between adjacent chairs.

FIG. 29 shows a perspective view of a seated patient with a single-member embodiment strapped to her legs.

FIG. 30 shows a perspective view of a seated patient with a single-member embodiment strapped to her legs and a caregiver preparing to assist her in standing.

FIG. 31 shows a perspective view of a single-member embodiment.

FIG. 32 shows a cross-sectional view of the embodiment of FIG. 31.

FIG. 33 shows a top plan view of the embodiment of FIG. 31.

FIG. 34 shows a front elevation view of the embodiment of FIG. 31.

FIG. 35 shows a side elevation view of the embodiment of FIG. 31.

FIG. 36 shows a top plan view of the embodiment of FIG. 31 with an attached strap.

FIG. 37 shows a perspective view of a single-member embodiment with additional strap attachment rings.

FIG. 38 shows a top plan view of the embodiment of FIG. 37.

FIG. 39 shows a front elevation view of the embodiment of FIG. 37.

FIG. 40 shows a side elevation view of the embodiment of FIG. 37.

FIG. 41 shows a top plan view of the embodiment of FIG. 37 with two attached straps.

FIG. 42 shows a perspective view of an embodiment with two horizontal members and hinged assemblies between the two horizontal members.

FIG. 43 shows a side elevation view of the embodiment of FIG. 42.

FIG. 44 shows a front elevation view of the embodiment of FIG. 42.

FIG. 45 shows a top plan view of the embodiment of FIG. 42.

FIG. 46 shows an exploded perspective view of a hinge assembly of FIG. 42.

FIG. 47 shows an enlarged perspective view of the concave surface of a friction washer.

FIG. 48 shows an enlarged perspective view of the flat surface of a friction washer.

FIG. 49 shows a side elevation view of the hinged embodiment of FIG. 42 positioned on a patient's knees.

FIG. 50 shows a side elevation view of the embodiment of FIG. 49 with the patient rising from a seated position.

FIG. 51 shows a side elevation view of the embodiment of FIG. 49 with the patient standing erect.

### DETAILED DESCRIPTION OF THE PREFERRED EMBODIMENTS

Since the inventive apparatus and related methods of use are most often employed during the provision of health care, the assisting person will hereafter be referred to as a caregiver and the assisted person as a patient, with the understanding that the invention is not limited to medical applications and the people utilizing the invention are not necessarily patients or health care providers.

Several embodiments of the invention have been found to be useful. Each has one concavity flanked on either side by at least two opposing concavities to form at least in part a shape roughly resembling a letter “M” or “W.”

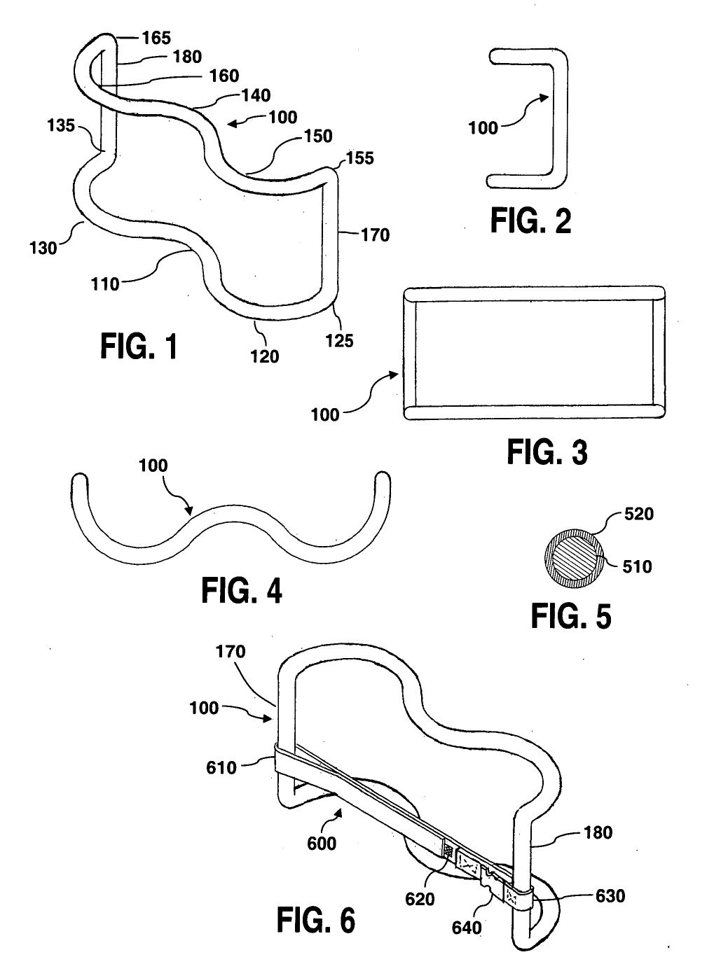

FIG. 1 shows a perspective view of an embodiment 100 fabricated from cylindrical stock to form a frame. The rounded curve of a lower central concavity 110 reverses at each end to form opposing right 120 and left 130 lower peripheral concavities. A parallel upper central concavity 140 similarly reverses at each end to form opposing right 150 and left 160 upper peripheral concavities. The outer end 125 of the right lower peripheral concavity 120 is joined by a right side member 170 to the outer end 155 of the right upper peripheral concavity 150. The outer end 135 of the left lower peripheral concavity 130 is joined by a left side member 180 to the outer end 165 of the left upper peripheral concavity 160.

In other embodiments the section between the upper, outer ends 155, 165 may be straight, omitting concavities entirely. The concavities may be curved as already described, or rectangular, triangular, or any other shape that is deemed desirable. The right and left side members may be shaped to function as handles. In general, the section between the upper, outer ends 155, 165 is separated from the section between the lower, outer ends 125, 135 by a distance that spans a person's knee from a point below mid-femur and above the knee to a point above mid-tibia and below the knee.

FIG. 2 shows a side elevation view of the embodiment of FIG. 1. FIG. 3 shows a front elevation view of the embodiment of FIG. 1. FIG. 4 shows a top plan view of the embodiment of FIG. 1. FIG. 5 shows a cross-sectional view of the embodiment of FIG. 1. Other embodiments may have oval, square, rectangular, or other known cross-sectional shapes. The embodiment of FIG. 5 has a solid core 510 with an outer layer 520 of non-absorbent, easily-cleaned, slip-resistant closed-cell synthetic foam or other known cushioning material surrounding the tubing. Other embodiments may be fabricated from hollow or internally reinforced tubing.

The embodiment 100 of FIG. 1 can be made of metal, fiberglass, plastic, composite materials, and/or other materials known in the art. Although the embodiment 100 of FIG. 1 is formed from a continuous length of stock joined at some convenient point to form a loop, other embodiments can be made of discrete components that may use button locks, screws, nuts and bolts, and other known fastening systems to attach to or interlock with each other, and to telescope in and out of each other.

An embodiment with discrete components may be disassembled for easy transport and may be resized by substitution of components. Telescoping components may allow incremental or continuous adjustments of the size and proportions of the invention. Another embodiment may omit the upper concavities and side members entirely, relying only on a central concavity with opposed peripheral concavities.

Still another embodiment may be created from a flat panel that is cast, molded, or formed to have a central concavity with two opposing peripheral concavities. However, an open frame or single “M” or “W” bar with a cushioned surface avoids pressure on kneecaps. Any embodiment is light and compact enough to be easily stored and transported by a mobile caregiver.

FIG. 6 shows an embodiment 100 with an adjustable strap 600 used to secure the apparatus to a patient's legs. In the embodiment of FIG. 6 one end of the strap comprises a loop 610 that passes around either the right 170 or left side member and is secured in place by hook and loop material 620. The other end of the strap comprises a second loop 630 that passes around the right or left 180 side member and is secured by a side release buckle 640 or other fastener known in the art.

Overall strap length may be adjusted by changing the length of the first loop 610. The strap may be quickly buckled and unbuckled by using the side release buckle 640 to open and close the second loop 630. The fastener is usually positioned on the patient's right side when a caregiver uses his or her right knee to push against the apparatus, and on the patient's left side when a caregiver uses his or her left knee to push against the apparatus. This allows for quick and easy access by the caregiver's hand (which can be safely freed), and positions the buckle on the side opposite the knee the caregiver uses to push against the apparatus.

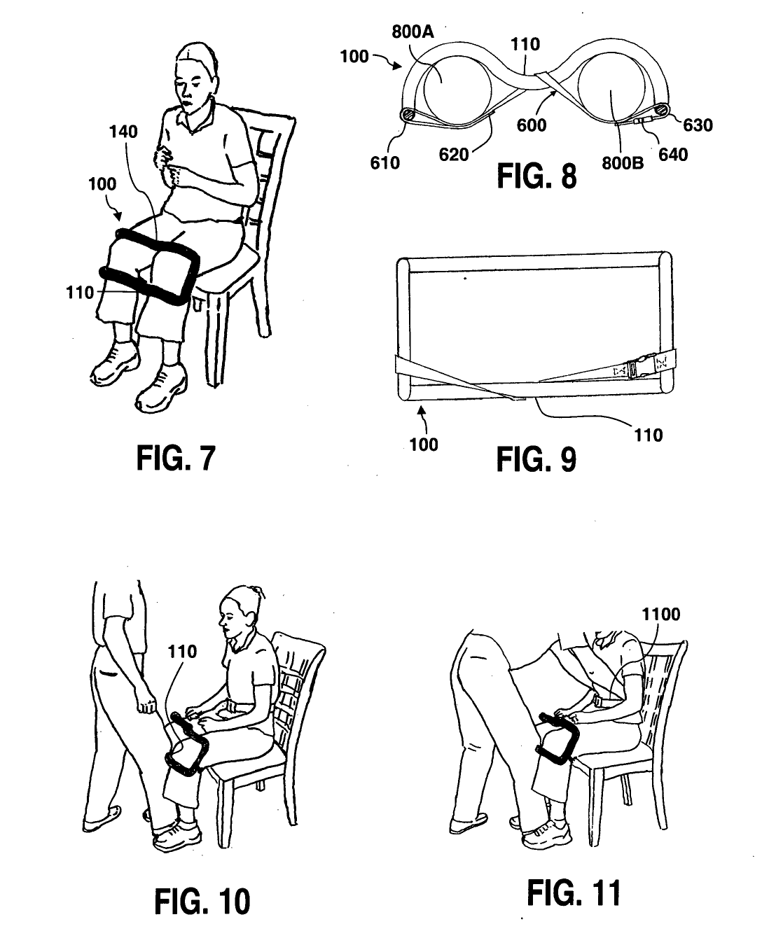

FIGS. 7 through 13 show an exemplary method for using the embodiment of FIG. 1 to help a two-legged patient move from a sitting position to a standing position. Any embodiment may be used to accomplish this move in a similar manner. The embodiment of FIG. 1 is placed over the knees of a seated patient with the upper central concavity 140 above and between the knees, the lower central concavity 110 below and between the knees, and the peripheral concavities 120, 130, 150, 160 cradling the knees. In an embodiment with no upper concavities, the lower concavities 110, 120, 130 are again placed below the knees.

FIG. 8 shows a top cross-sectional view of the embodiment of FIG. 1 attached to a patient's legs. When a strap 600 is used to attach an embodiment to a two-legged patient, the strap 600 may be secured by looping one end 630 around a side member and fastening the buckle 640, passing the strap 600 behind a leg 800B, passing the strap 600 around the front of the lower central concavity 110, passing the strap 600 behind the other leg 800A, looping the other end 610 of the strap 600 around the other side member, and securing the hook-and-loop fastener 620 in a position that comfortably secures the embodiment. The strap 600 may later be quickly removed by releasing the buckle 640.

FIG. 9 shows a rear elevation view of the same attachment. This attachment method prevents the apparatus from slipping out of position and helps to keep the patient's knees within the peripheral concavities, so that the patient's knees are locked together for improved stability and safety. An embodiment with only one central concavity flanked by opposed concavities should be strapped on or otherwise secured to hold the embodiment in position.

Attached or not, once the apparatus is positioned on the patient's knees the standing caregiver faces the seated patient, places a supporting foot between the patient's feet in the manner shown in FIG. 10, then presses the caregiver's knee on the same side as the supporting foot into the lower central concavity 110. Since the caregiver's kneecap is now between and behind the patient's kneecaps, opposing pressure between the central concavity and the peripheral concavities tends to stabilize both the apparatus and the three knees pressed into the apparatus, with the knees in the peripheral concavities in effect balanced on and suspended from the knee supporting the central concavity.

This arrangement of force vectors produces a much higher degree of dynamic stability than could be obtained from an arrangement where the same set of knees are pressed against opposite sides of a flat panel or a strut. Moreover, the three knees are fixed in their respective positions and co-located closely enough to function as a single broad pivot or fulcrum with considerable side-to-side stability. With body weight fixing in place the caregiver's supporting foot and the patient's feet, and the apparatus fixing their knees together, a stable pillar supporting a pivot is created that allows the balancing body weights of the caregiver and patient to rock about the pivot.

The caregiver may gain a mechanical advantage by shifting body weight back from the pivot while drawing the patient's body weight close to the pivot. In this way even a relatively small caregiver may move a relatively large patient. The apparatus decreases the load on the neck, back, and extremities of the caregiver, thus reducing the likelihood of back injuries, musculoskeletal disorders, and work-related injuries. In addition to its other properties, the apparatus is easily grasped, so that a patient who has some arm strength may assist the caregiver by grasping the apparatus in the manner of a handle and pulling his or her upper body toward the caregiver, thus reducing the force the caregiver must apply to pivot the patient upward. The patient may also grasp the apparatus simply to maintain balance.

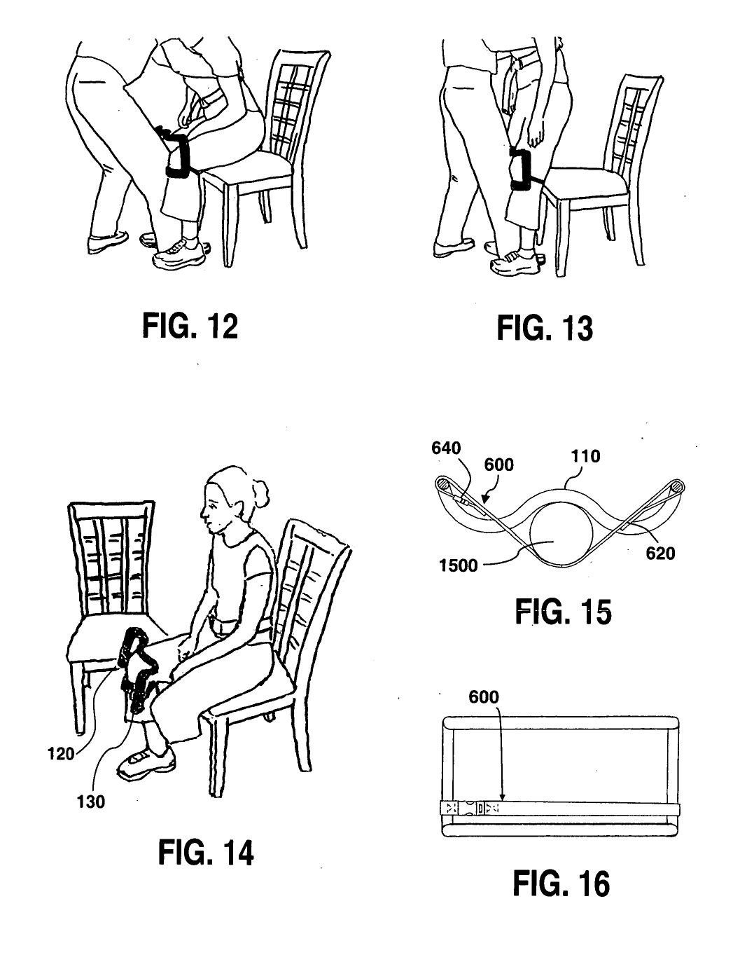

Reaching forward to grasp the patient as shown in FIG. 11, possibly by a belt 1100, the caregiver rocks his or her body weight back from the patient in the manner shown in FIG. 12, then pivots the patient forward and upward about the three knees to the standing position shown in FIG. 13. The caregiver usually achieves better control and mechanical advantage by grasping the patient as close to the hips as is feasible. The same method may be used to move a patient with an embodiment having only a central concavity flanked by opposing peripheral concavities.

All embodiments may be used in a similar fashion to assist a one-legged person or a two-legged person who cannot use one leg because of a non-weight-bearing fracture, cellulitis, or another disabling condition. It should be understood that references to and drawings of one-legged persons refer both to amputees and to two-legged persons who are unable to bear weight on one leg.

As shown in FIGS. 14 and 15, the apparatus is reversed and the lower central concavity 110 is positioned just below the knee of the patient's single leg 1500. If the apparatus is strapped on, the strap 600 is looped around one side member and the buckle 640 fastened, the strap 600 is passed behind the patient's leg 1500, then the strap 600 is passed around the opposite side member and the hook-and-loop fastener 620 secured as shown in FIG. 15. FIG. 16 shows a front elevation view of the strap configuration of FIG. 15.

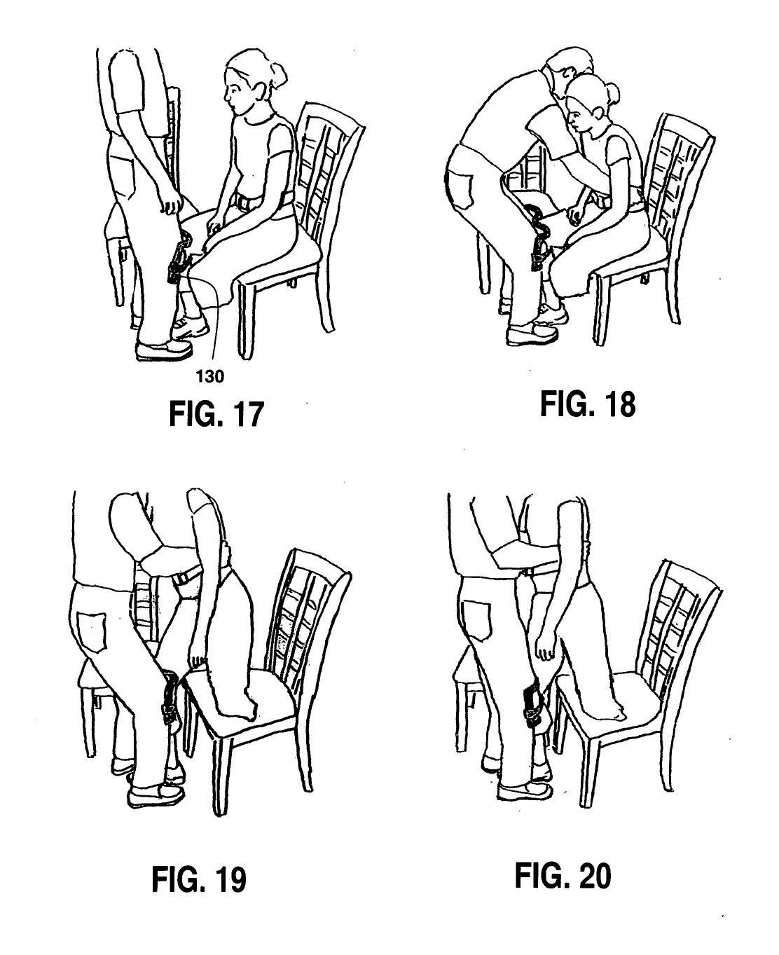

A caregiver faces the patient and places his or her feet on either side of the foot on the patient's only supporting leg, at least partially straddling the patient's foot. The caregiver's knees are pressed into the lower peripheral concavities 120, 130 as shown in FIG. 17. The caregiver grasps the patient, possibly in the manner shown in FIG. 18, then the caregiver rocks his or her weight backwards, causing the patient to pivot forward and rise to a standing position as shown in FIGS. 19 and 20.

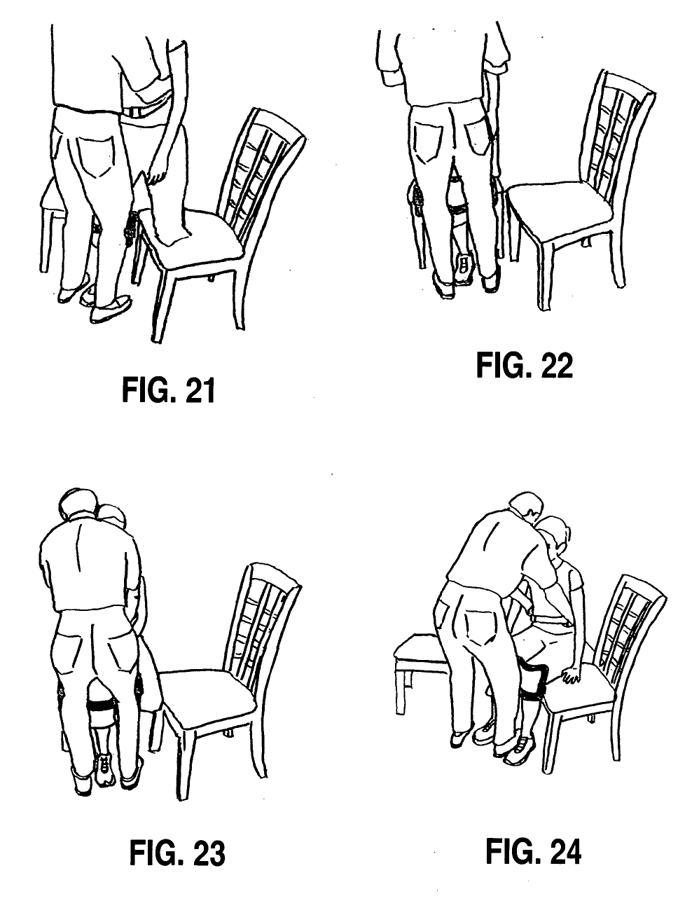

Once the patient is standing the patient may move or be moved in a variety of ways. FIGS. 21 and 22 show an operation where the standing patient of FIG. 20 is rotated from one chair to another. Once the patient is correctly positioned with respect to the new chair, the caregiver reverses the standing process by balancing the patient's weight with the caregiver's weight, then rocks forward to ease the patient into the new chair as shown in FIG. 23. As shown in FIGS. 27 and 28, the same shift may be accomplished for a two-legged patient using the method for standing already described, rotating the patient to the new chair, then reversing the two-legged assisted stand to ease the patient into a new seated position.

In some cases it is desirable to shift the patient's position without having the patient stand completely. This is often the case where the patient is so obese that the caregiver is unable to raise the patient or uncertain as to whether the patient would be stable if raised. In this situation the caregiver may use either the one-legged or two-legged method to raise the patient enough to slide the patient laterally between a bed and chair or other supporting surfaces. The apparatus may be used in conjunction with a sliding board, transfer disk, transfer belt (gait belt) or similar device.

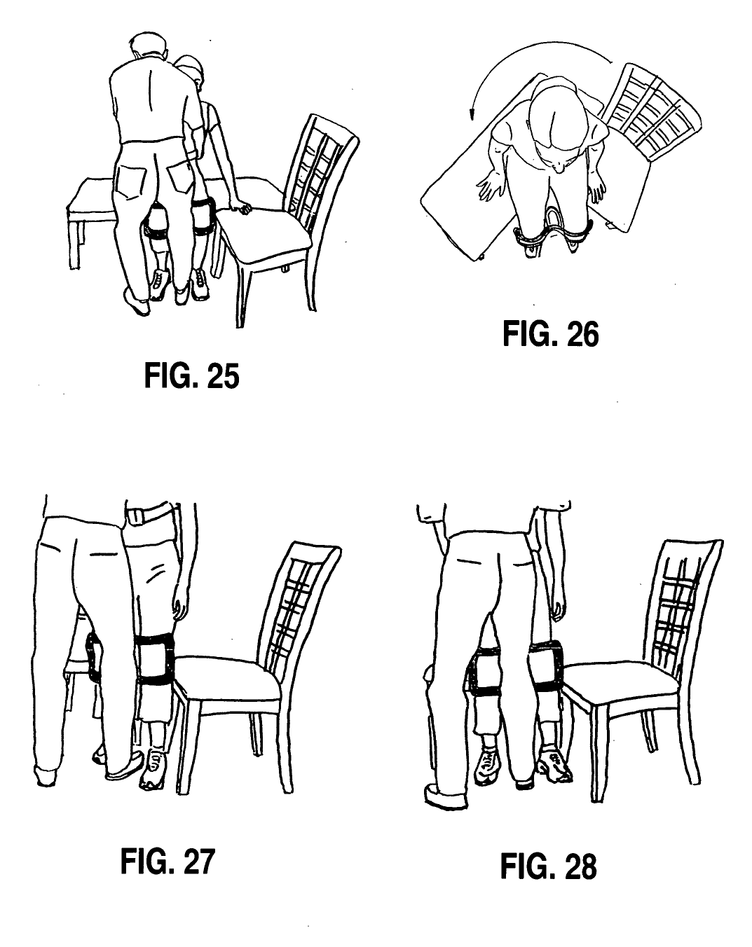

FIGS. 24 and 25 show a caregiver shifting a two-legged patient from a chair to a bed. As shown in FIG. 24, the patient is lifted from the chair just enough to slide freely. The patient is rotated laterally to the bed, as shown in FIG. 25, then eased down onto the bed. FIG. 26 shows a top plan view of the motion of the shifted patient. The same shift may be accomplished for a person with only one weight-bearing leg using methods described above. Once any of the movements described above is accomplished the apparatus may be quickly removed by releasing the strap buckle.

The movements described above may also be effected using any of the previously-disclosed methods with a simplified embodiment of the invention that consists of a single “M” or “W” member. FIG. 31 shows such a single-member embodiment 3100 with an attached strap 3160 in a storage position. As in the embodiment of FIG. 1, a rounded curve of a central concavity 3110 reverses at each end to form opposing right 3120 and left 3130 peripheral concavities.

Strapping or otherwise securing any embodiment to a patient's legs holds the patient's knees in a fixed position relative to each other and prevents the embodiment from shifting position when a patient moves. This is particularly helpful when a patient has a weak leg that may shift position unexpectedly during movement, causing a momentary misalignment of the invention and a partial loss of contact. An embodiment with only one central concavity flanked by opposed concavities should be strapped on or otherwise secured to hold the embodiment in position.

Since the single-member embodiment 3100 lacks an attached parallel upper member that may rest upon a patient's upper leg to hold the apparatus in place, a strap 3160 is especially helpful in positioning the single-member embodiment 3100 prior to application of counter-pressure by a caregiver's knee or knees. The strap 3160 is identical to the adjustable strap 600 of FIG. 6 except that, rather than looping around side members, the strap 3160 loops through rings 3140, 3145 affixed to or co-molded with the ends 3125, 3135 of the member 3100.

FIG. 32 shows a cross-sectional view of the embodiment of FIG. 31, which may be made of the same materials, by the same processes, and in the same cross-sectional shapes as the embodiment of FIG. 5. FIG. 33 shows a top plan view, FIG. 34 a front elevation view, and FIG. 35 a side elevation view of the embodiment of FIG. 31. FIG. 36 shows an alternate method for attaching the member 3100 to a patient by passing the strap 3160 behind a first leg 3600B, around the front of the central concavity 3110, behind a second leg 3600A, and securing it in the manner described for the embodiment of FIG. 8, with the difference that the strap 3160 passes through end rings 3140, 3145 rather than around side members.

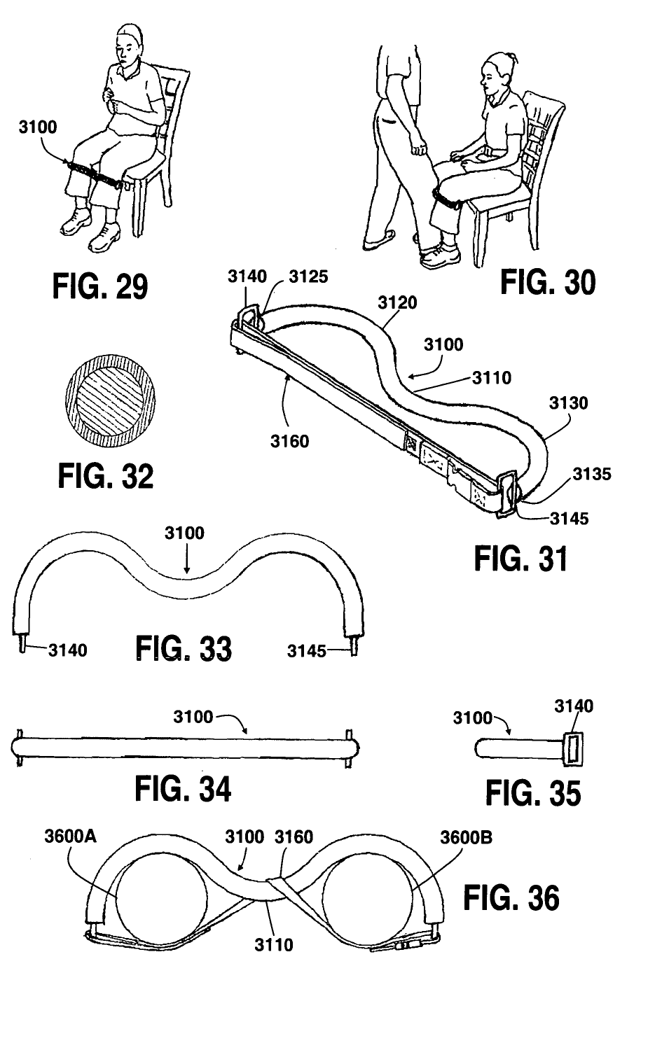

FIG. 29 shows a seated patient with the single-member embodiment 3100 strapped to the patient's lower legs using the method illustrated in FIG. 36. A caregiver may then engage the apparatus as shown in FIG. 30 and proceed with any of the movements described for any of the other embodiments of the invention.

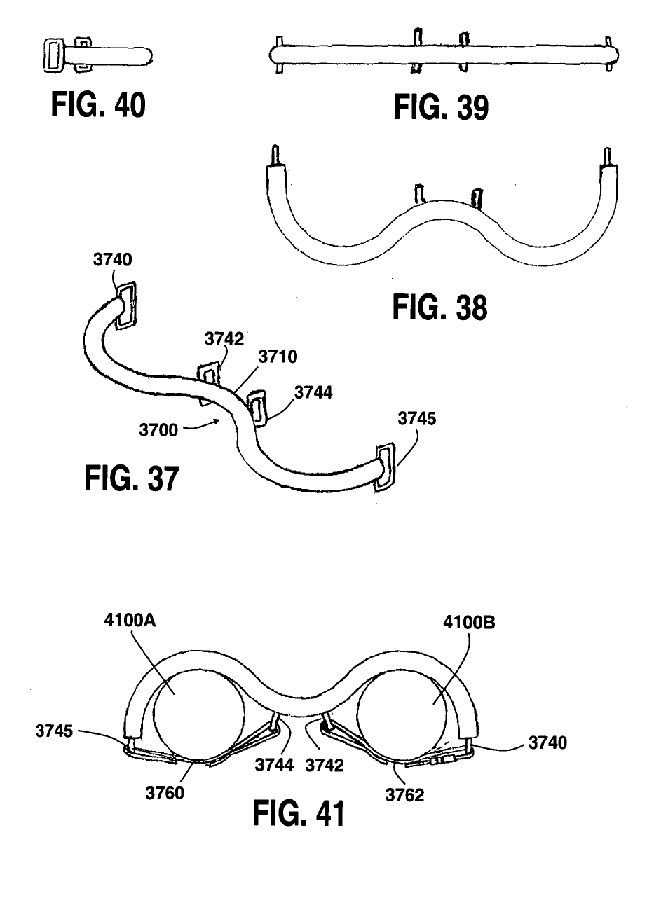

Another single-member embodiment may provide an additional set of rings that allow the use of a separate strap for each of the patient's legs. FIG. 37 shows a single-member embodiment 3700 with strap attachment rings 3740, 3745 at either end, as in the embodiment of FIG. 31, but with additional rings 3742, 3744 attached to or co-molded slightly to either side of the center of the central concavity 3710. FIG. 38 shows a top plan view, FIG. 39 a front elevation view, and FIG. 40 a side elevation view of the embodiment of FIG. 37. The embodiment of FIG. 37 may be made of the same materials, by the same processes, and in the same cross-sectional shapes as the embodiment of FIG. 5.

FIG. 41 shows a method for attaching the member 3700 to a patient by buckling or otherwise affixing a first strap 3760 through a first ring 3744, passing the first strap 3760 behind a first leg 4100A, passing the first strap 3760 through a second ring 3745, and securing the end of the first strap 3760 to itself with a hook-and-loop closure or other known method as described for the embodiment of FIG. 8. The same procedure may be repeated for a second leg 4100B with a second strap 3762 secured to third 3740 and fourth 3742 rings. While this attachment method is somewhat more time-consuming than those previously described, it does provide a caregiver with the ability to apply different amounts of strap pressure to each leg. The single-member embodiments 3100, 3700 provide a somewhat lighter, more compact, and less expensive alternative to two-member embodiments.

Although the embodiment of FIG. 1 rests securely on a seated patient's knees without a strap, force applied by a caregiver's knee or knees against the lower central concavity or lower peripheral concavities of the embodiment of FIG. 1 may initially cause the upper concavities to swing away from the patient's thigh. This occurs because the concavities of the embodiment of FIG. 1 are coplanar and the force of a caregiver's knee or knees reacted by the patient's knee or knees tends to drive opposing concavities in opposite directions, so that the plane of the concavities under pressure by opposing knees tends to rotate until it becomes orthogonal to the lower legs of the patient and caregiver. This transitory condition is apparent in FIG. 12. The patient's upper leg ordinarily re-engages the upper concavities once the patient is nearly upright.

The initial swing may be reduced by angling the plane of the upper concavities with respect to the plane of the lower concavities so that the plane of each set of concavities is more nearly orthogonal to the portion of the patient's leg it touches. In one alternate embodiment the invention may be permanently formed or fabricated with the planes of the upper and lower concavities angled with respect to each other. However, since the angle between upper and lower portions of a patient's leg changes as a patient stands and sits, no fixed angle can be optimum for every position.

Single-member embodiments are unrestrained by additional members and therefore automatically rotate to an optimum concavity angle when strapped onto a patient's lower leg. Optimum concavity angles may be maintained by embodiments with more than a single member by allowing the plane of at least one set of concavities to rotate continuously with respect to the plane of the other set, allowing each set of concavities to maintain contact with and at optimum angle with respect to the patient's leg as the patient stands and sits.

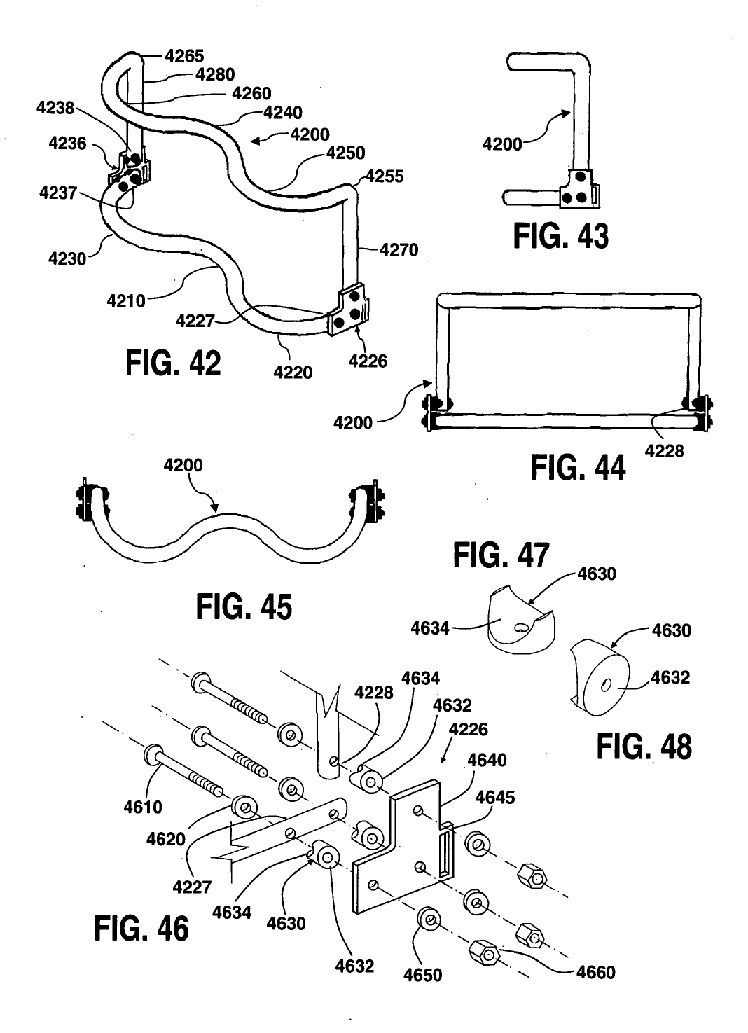

FIG. 42 shows a perspective view of an embodiment 4200 with lower concavities that pivot about hinge assemblies 4226, 4236. Apart from the hinges, the embodiment of FIG. 42 shares the characteristics of the embodiment of FIG. 1, with the rounded curve of a lower central concavity 4210 reversing at each end to form opposing right 4220 and left 4230 lower peripheral concavities. A parallel upper central concavity 4240 similarly reverses at each end to form opposing right 4250 and left 4260 upper peripheral concavities.

The outer end 4227 of the right lower peripheral concavity 4220 is joined by a hinge assembly 4226 to a lower right side member end 4228 of a right side member 4270, which in turn joins the outer end 4255 of the right upper peripheral concavity 4250. The outer end 4237 of the left lower peripheral concavity 4230 is similarly joined by a hinge assembly 4236 to a lower left side member end 4238 on a left side member 4280 which in turn joins the outer end 4265 of the left upper peripheral concavity 4260. FIGS. 43, 44, and 45 respectively show side elevation, front elevation, and top plan views of the embodiment 4200 of FIG. 42.

In other embodiments, the section between the upper, outer ends 4255, 4265 may be straight, omitting concavities entirely, or may have hinges similar to those connecting the lower side members and concavities. The concavities may be curved as already described, or rectangular, triangular, or any other shape that is deemed desirable. The right and left side members may be shaped to function as handles. In general, the section between the upper, outer ends 4255, 4265 is separated from the section between the lower, outer ends 4227, 4237 by a distance that spans a person's knee from a point below mid-femur and above the knee to a point above mid-tibia and below the knee.

FIG. 46 shows an exploded view of a hinge assembly 4226. A plate 4640 is secured to the outer end 4227 of the right lower peripheral concavity 4220 with two fastener sets. Each fastener set has a bolt 4610 that passes through a first flat washer 4620, the outer end 4227, a friction washer 4630 with opposing flat 4632 and concave 4634 surfaces, the plate 4640, a second flat washer 4650, and a lock nut 4660. FIGS. 47 and 48 show enlarged perspective views of the friction washer 4630, with FIG. 47 showing the concave surface 4634 and FIG. 48 showing the flat surface 4632. The friction washer may be made of plastic or other suitable materials known in the art.

A single fastener set secures the lower right side member end 4228 of the right side member 4270 to the plate 4640, forming a pivot. When the fastener sets are tightened the concave surface 4634 of a friction washer locks against the lower right side member end 4228 while the flat surface 4632 of the friction washer presses against the plate 4640. Friction between the friction washer and the plate prevents the hinge assembly from moving freely in response to only gravity while allowing the angles of the concavities to adjust easily in response to manual manipulation or pressure against a patient's leg. An optional ring 4645 provides a convenient attachment point for straps as previously described.

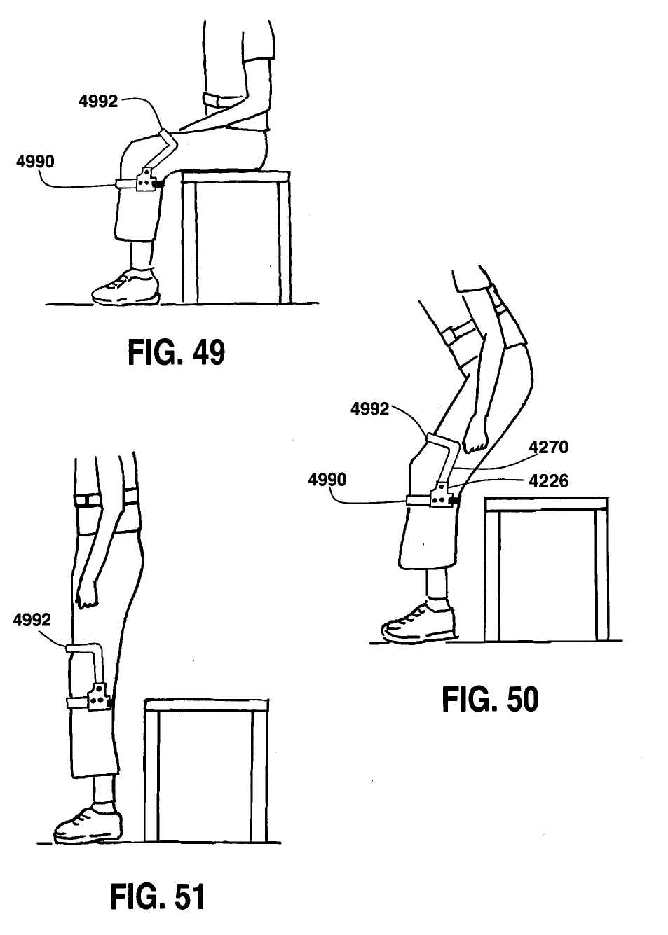

FIG. 49 shows the result of such an adjustment. The lower set of concavities 4990 are angled so that the plane of the concavities is orthogonal to the patient's lower legs, while the upper concavities 4992 rest comfortably against the patient's upper legs. If a caregiver applied opposing force to the lower set of concavities 4990 in the embodiment of FIG. 49 the lower set of concavities 4990 would not rotate, allowing the upper set of concavities 4992 to remain in contact with the patient's legs instead of swinging away as in FIG. 12.

As the patient begins to stand and straighten the legs as in FIG. 50, the hinges 4226 (4236 is not visible) allow the lower set of concavities 4990 to remain orthogonal to the patient's lower leg while the side members 4270 (4280 is not visible) and the upper concavities 4992 rotate, allowing the upper concavities 4992 to maintain continuous contact with the patient's legs. When the patient is fully erect as shown in FIG. 51, the upper concavities 4992 are orthogonal to the patient's thighs.

Self-adjustment of the angles of the concavities, as in single member embodiments and frame embodiments with hinge assemblies, increases patient comfort and maintains contact between the patient's legs and both upper and lower sets of concavities, improving stability. The ability of a set of concavities to be adjusted or to self-adjust to maintain a consistent orientation with respect to a patient's legs reduces the need for the concavities to have a circular cross-section. Instead, the concavities may have a square, rectangular, thin and flat, or other cross-sectional shape that presents a substantially flat surface to the patient's leg or legs, thereby increasing the surface area of contact and better distributing contact pressure. Wide and even distribution of contact pressure greatly reduces patient discomfort.

Without adjustment capability, an embodiment similar to that of FIG. 1 but made with a rectangular or flat cross-section would demonstrate a greater tendency to swing in response to force applied by a caregiver than an embodiment with a circular cross-section. The embodiment of FIG. 1 (with a circular cross-section) rolls continuously in response to a caregiver's pressure and maintains a substantially consistent area of contact with a patient's lower leg or legs. An embodiment with a substantially flat cross-section would press the upper edge of the lower set of concavities against a patient's lower leg or legs and the lower edge of the lower set of concavities against the caregiver's leg or legs, concentrating pressure against both and holding the caregiver's leg or legs back from the patient's leg or legs.

When the caregiver applies pressure, the lower set of concavities tend to pivot about one or both edges, forcing one or both edges to slide and scrape against the legs of the patient and/or caregiver. As the caregiver presses further and the lower set of concavities rotates and aligns with the patient's lower leg or legs, the change in distance between the caregiver's knee or knees and the patient's knee or knees may diminish so much that the caregiver's forward foot or feet must be repositioned to maintain stability. This is difficult to do without disrupting the pillar-and-pivot structure created by the invention. Single member embodiments and frame embodiments with hinge assemblies that allow continuous angular adjustment and contact are therefore highly beneficial when fabricated by material with a substantially flat cross-section.

Any embodiment of the invention may also be used as a tool for handling stroke patients and other persons who may not need to change position but require assistance during medical or therapeutic procedures. Any embodiment of the invention may be used to assist during rehabilitation, with maintenance of sitting or standing balance or certain postures, to facilitate trunk control and arm functions while dressing, with feeding, and during other activities. Any embodiment of the invention may be used to ensure that a patient will not slide off the edge of a bed. In any of these circumstances an embodiment of the apparatus is positioned on the patient and used in a manner described above, with the differences that the patient may be lifted only slightly or not at all, and the caregiver may grasp the patient in a manner that is not advantageous for lifting but more suited to balance or posture adjustment.

The apparatus and methods described above allow caregivers to maintain good balance, close contact and optimum control while moving patients. The principles, embodiments, and modes of operation of the present invention have been set forth in the foregoing specification. The embodiments disclosed herein should be interpreted as illustrating the present invention and not as restricting it. The foregoing disclosure is not intended to limit the range of equivalent structure available to a person of ordinary skill in the art in any way, but rather to expand the range of equivalent structures in ways not previously contemplated. Numerous variations and changes can be made to the foregoing illustrative embodiments without departing from the scope and spirit of the present invention.

1. An apparatus for handling a person comprising
a single member having a central concavity, a first peripheral concavity, and a second peripheral concavity, the first and second peripheral concavities connected to the central concavity at opposite sides thereof and opening in a first direction, the central concavity opening in an opposite direction, each concavity sized and shaped to comfortably accept a portion of human leg adjacent the knee; and
a first ring and a second ring, the first and second rings having an opening to receive at least a portion of a strap therein, the first ring disposed at an outer end point of the first peripheral concavity, the second ring disposed at an outer end point of the second peripheral concavity.

2. The apparatus for handling a person according to claim 1, wherein the single member is fabricated from tubing and encased in cushioning material.

3. The apparatus for handling a person according to claim 2, wherein the single member has a generally rectangular cross-section.

4. The apparatus for handling a person according to claim 1, wherein the single member is fabricated from solid material and encased in a cushioning material.

5. The apparatus for handling a person according to claim 1, further comprising a strap, a portion of the strap passing through each of the openings of the first ring and the second ring.

6. The apparatus for handling a person according to claim 1, further comprising a third ring, and a fourth ring, the third and fourth rings having an opening to receive at least a portion of a strap therein, the third ring disposed at an inner end point of the first peripheral concavity, and the fourth ring disposed at an inner end point of the second peripheral concavity.

7. The apparatus for handling a person according to claim 6, further comprising:
a first strap, a portion of the first strap passing the openings of the first and third rings, and;
a second strap, a portion of the second strap passing the openings of the second and fourth rings.

8. An apparatus for handling a person comprising:
a first member having a central concavity, a first peripheral concavity, and a second peripheral concavity, the first and second peripheral concavities connected to the central concavity at opposite sides thereof and opening in a first direction, the central concavity opening in an opposite direction, each concavity sized and shaped to comfortably accept a portion of human leg adjacent the knee;
a second member having a central concavity, a first peripheral concavity, and a second peripheral concavity, the first and second peripheral concavities connected to the central concavity at opposite sides thereof and opening in a first direction, the central concavity opening in an opposite direction, each concavity sized and shaped to comfortably accept a portion of human leg adjacent the knee;
at least one third member extending between the first and second members to separate the first and second members by a distance sufficient to span a human knee from above the knee to below the knee; and
at least one hinge assembly, the at least one hinge assembly rotatably attaching the at least one third member to the second member.

9. The apparatus for handling a person according to claim 8, wherein the at least one third member comprises two third members.

10. The apparatus for handling a person according to claim 9, wherein the two third members are integral with opposite ends of the first member.

11. An apparatus for handling a person comprising:
a frame, the frame further comprising:
a lower portion having a central concavity, a first peripheral concavity, and a second peripheral concavity, the first and second peripheral concavities connected to opposite sides of the central concavity and opening to a first direction, the central concavity opening to the opposite direction, each concavity sized and shaped to comfortably accept a human knee, the first and second peripheral concavities disposed with respect to the central concavity so that a knee inserted in the central concavity is a least partially between two knees inserted in the first and second peripheral concavities; and
an upper portion substantially parallel to the lower portion of the frame, the upper portion of the frame separated from the lower portion of the frame by a distance sufficient to span a person's knee from a point below mid-femur and above the knee to a point above mid-tibia and below the knee; and
a hinge assembly connecting the upper portion of the frame to the lower portion of the frame.

12. The assembly for handling a person according to claim 11, wherein the hinge assembly includes a friction washer.

13. The assembly for handling a person according to claim 11, wherein the frame is fabricated from tubing and encased in cushioning material.

14. The assembly for handling a person according to claim 13, wherein the tubing has a rectangular cross-section.

15. The assembly for handling a person according to claim 11, wherein the frame is fabricated from solid material and encased in cushioning material.

16. The apparatus for handling a person according to claim 11, further comprising a first ring and a second ring, the first and second rings having an opening to receive at least a portion of a strap therein, the first ring disposed on the lower portion at an outer end point of the first peripheral concavity, the second ring disposed on the lower portion at an outer end point of the second peripheral concavity.

17. The assembly for handling a person according to claim 11, further comprising a first side member connected to the upper portion of the frame, the first side connecting the upper portion to the lower portion through the hinge assembly.

18. The apparatus for handling a person according to claim 16, further comprising a third ring, and a fourth ring, the third and fourth rings having an opening to receive at least a portion of a strap therein, the third ring disposed on the lower portion at an inner end point of the first peripheral concavity, and the fourth ring disposed on the lower portion at an inner end point of the second peripheral concavity.
